(19) United States
(12) Patent Application Publication
(10) Pub. No.: US 2003/0065907 A1
(43) Pub. Date: Apr. 3, 2003

(54) Program-controlled unit having a prefetch unit

(76) Inventors: Steffen Sonnekalb, Munchen (DE); Jurgen Birkhauser, Munchen (DE)

Correspondence Address: LERNER AND GREENBERG, P.A., Post Office Box 2480, Hollywood, FL, 33022-2480, US

(21) Appl. No.: 10/230,773

(22) Filed: Aug. 29, 2002

Related U.S. Application Data
(63) Continuation of application No. PCT/DE01/00584, filed on Feb. 14, 2001.

(30) Foreign Application Priority Data
Feb. 29, 2000 (DE) 100 09 677.8

(51) Int. Cl. G06F 9/44; G06F 9/00

(52) U.S. Cl. 712/207; 712/239

(57) ABSTRACT

A program-controlled unit stores return addresses not only in a system stack but also in a return stack. The instructions which have already been taken into the program-controlled unit, but are not currently required, are stored in a storage device for alternative instructions. At times when the program-controlled unit is not active elsewhere, instructions are taken into the program-controlled unit, whereby the instructions are to be carried out when an instruction is not carried out or is not carried out as expected.

### CROSS-REFERENCE TO RELATED APPLICATION

This application is a continuation of copending International Application No. PCT/DE01/00584, filed Feb. 14, 2001, which designated the United States and was not published in English.

### BACKGROUND OF THE INVENTION

### FEILD OF THE INVENTION

The present invention relates to a program-controlled unit containing a prefetch unit.

Such program-controlled units are, for example, microprocessors or microcontrollers which operate in accordance with the pipeline principle.

In program-controlled units operating in accordance with the pipeline principle, instructions to be executed are processed in a number of successive incremental steps, and different incremental steps can be executed simultaneously for different instructions. That is, while the nth incremental step is executed for an x^{th} instruction, the.(n−1)^{th} incremental step is simultaneously executed for an (x+1)^{th} instruction to be executed thereafter, the (n−2)^{th} incremental step is executed for an (x+2)^{th} instruction to be executed thereafter, etc. The number of incremental steps in which the instructions are executed differs in practice and can be specified arbitrarily, in principle.

Program-controlled units operating in accordance with the pipeline principle can execute the instructions to be executed by them in very rapid succession and, nevertheless, can have a relatively simple configuration; in particular, it is not necessary to provide units needed for instruction-execution several times even though it is possible to work on a number of instructions at the same time.

The speed advantage which can be achieved by program-controlled units operating in accordance with the pipeline principle can be lost in the case of instructions, the execution of which results in a jump. This is so because, if an instruction which results or can result in jump in the instruction processing pipeline is not followed by the instructions, which are to be executed thereafter, the execution of instructions must be interrupted until the instructions which are to be executed following the instruction which results or can result in a jump have been read out of the program memory and have passed through the existing pipeline stages up to the pipeline stage in which the instructions are executed. As a result, long pauses can occur in the instruction-execution following instructions, the execution of which results or can result in a jump.

### SUMMARY OF THE INVENTION

It is accordingly an object of the invention to provide a program-controlled unit having a prefetch unit that overcomes the hereinafore-mentioned disadvantages of the heretofore-known devices of this general type.

More specifically, the problem can be partially eliminated if one of the first pipeline stages (preferably the very first pipeline stage), which is generally formed by what is referred to as a prefetch unit:

searches the instructions for instructions, the execution of which results or can result in a jump;

predicts, for the instructions found during the process, whether their execution will result in a jump or not; and

depending on the result of the prediction, continues to operate in such a manner that following an instruction (the execution of which results or can result in a jump), the instruction which, according to the prediction, must be executed thereafter is provided for fetching by the unit for processing the instructions further.

With the foregoing and other objects in view, there is provided, in accordance with the invention, a program-controlled unit containing an address calculating unit, a program memory and a prefetch unit coupled to the address calculating unit and to the program memory. The prefetch unit s configured for reading data representing instructions out of the program memory, extracting the instructions and providing the instructions for fetching by the address calculating unit to process the instructions further, and searching the instructions for an instruction, an execution of which results or can result in a jump and predicting for the instruction found during the process if the execution of the instruction will result in a jump.

Depending on the result of the prediction, the prefetch unit continues to operate in such a manner that following the instruction, the execution of which results or can result in a jump, a further instruction which, according to the prediction, must be executed thereafter, is provided for fetching by the address calculating unit for processing the instructions further. A return address storage device is coupled to the address calculating and the return address storage device is configured for storing addresses of the instructions that must be executed after instructions, which initiate a continuation of a processing of an instruction sequence temporarily interrupted by an execution of other instructions.

In accordance with a further feature of the invention, the prefetch unit reads out the data stored in the program memory and subjects a number of instructions per clock period to actions to be performed on the instructions.

In accordance with an added feature of the invention, there is provided an instruction storage device. The address calculating unit is configured to provide instructions for fetching and to process the instructions by writing the instructions into the instruction storage device.

In accordance with an additional feature of the invention, the instructions stored in the instruction storage device can be read out sequentially by the address calculating unit for processing the instructions further.

In accordance with yet another feature of the invention, the prefetch unit includes instruction registers for temporarily storing and transferring the instructions to the instruction storage device.

In accordance with yet a further feature of the invention, there is provided an instruction processing pipeline having pipeline stages. The unit is one of the pipeline stages of the instruction processing pipeline.

In accordance with yet an added feature of the invention, the return address storage device includes entries and stores only addresses of the instructions to be executed following instructions which initiate a continuation of a processing of an instruction sequence temporarily interrupted by an execution of other instructions, and information relating to the entries in the return address storage device.

In accordance with yet an additional feature of the invention, the information relating to the entries includes a read flag for specifying if a relevant return address storage device entry has already been used.

In accordance with again another feature of the invention, the information relating to the entries includes a validity flag for specifying if the relevant return address storage device entry is valid.

In accordance with again a further feature of the invention, there is provided a system stack for storing the addresses.

In accordance with again an added feature of the invention, the return address storage device can be written into and read out of by the prefetch unit.

In accordance with again an additional feature of the invention, the instructions, which initiate the continuation of the processing of the instruction sequence temporarily interrupted by the execution of the other instructions, are return instructions.

In accordance with still another feature of the invention, the temporary interruption of the processing of the instruction sequence is caused by a call instruction.

In accordance with still a further feature of the invention, the temporary interruption is caused by an interrupt request.

In accordance with still an added feature of the invention, the return address storage device is divided into a several parts, into which addresses are written, and, out of which addresses are read in response to different events.

In accordance with still an additional feature of the invention, an entry is made in a (first) one of the parts, if an instruction initiating the temporary interruption of the processing of the instruction sequence is written into the instruction storage device.

In accordance with another further feature of the invention, the entry is made in (a second one) another of the parts, if the instruction initiating temporary interruption of the processing of the instruction sequence is prepared for execution in one of the instruction processing pipeline stages following the prefetch unit.

In accordance with another further feature of the invention, the entry in the second part is made by an instruction processing pipeline stage by which addresses needed for executing the instruction currently located therein and for instructions to be executed later are determined.

In accordance with another further feature of the invention, the instruction processing pipeline stage that writes into the second part contains an address register and writes the determined addresses into the instruction address register.

In accordance with another further feature of the invention, the instruction processing pipeline stage includes an alternative instruction address register, and in the event a preceding instruction is an instruction which results or can result in a jump, determines an address of an instruction to be executed if the preceding instruction will not be executed as predicted, and writes the address into the alternative instruction address register.

In accordance with another further feature of the invention, the alternative instruction address register is a part of the second return address storage device part intended for instruction address storage.

In accordance with another further feature of the invention, the entry is made in a third (further) one of the return address storage device parts, if it is established that the instruction initiating the temporary interruption of the processing of an instruction sequence is executed as predicted.

In accordance with another further feature of the invention, the entry in the third part is made by transferring one of the entry made in the first one of the parts and the entry made in the one of the parts into the third return address storage device part.

In accordance with another further feature of the invention, an instruction address stored in the second part is transferred into the third part if an instruction, which must be executed following the instruction initiates the temporary interruption of the processing of the instruction sequence, is located in the instruction processing pipeline stage that writes into the second part.

In accordance with another further feature of the invention, the return address storage device entries are flagged as valid and unread upon being entered into the return address storage device.

In accordance with another further feature of the invention, the entries in the first and parts are flagged as invalid when the entry in the second return address storage device part is transferred into the third return address storage device part.

In accordance with another further feature of the invention, the entries in the first and second parts are flagged as invalid if it is found that the instruction initiating the temporary interruption of the processing of the instruction sequence is not executed as predicted.

In accordance with another further feature of the invention, when an instruction occurs, which initiates the continuation of a processing of an instruction sequence temporarily interrupted by execution of other instructions, an address of an instruction to be executed following the occurred instruction is read out of the return address storage device.

In accordance with another further feature of the invention, the prefetch unit, when an instruction occurs, which initiates the continuation of a processing of an instruction sequence temporarily interrupted by the execution of other instructions, first looks in the first part to see if the first part contains a valid and unread entry, and, if affirmative, uses the entry as an associated return address.

In accordance with another further feature of the invention, the prefetch unit, if no valid and unread entry exists in the first part, looks in the second part to see if the second part contains a valid and unread entry and, if affirmative, uses the entry as the associated return address.

In accordance with another further feature of the invention, the prefetch unit, if no valid and unread entry exists in the second part either, looks in the third part to see if the third part contains a valid and unread entry and, if affirmative, uses the entry as the associated return address.

In accordance with another further feature of the invention, an entry used as an associated return address is flagged as read.

In accordance with another further feature of the invention, a return address storage device entry already flagged as read is again flagged as unread if an instruction, in response to the occurrence of which the return address storage device entry has been read out and used as the return address, is not executed as predicted.

In accordance with another further feature of the invention, a return address storage device entry is flagged as invalid if it is established that an instruction, in response to the occurrence of which a relevant return address storage device entry has been read out and used as the return address, is executed as predicted.

In accordance with another further feature of the invention, there is provided a mechanism for comparing a return address obtained from the return address storage device with another return address stored in the system stack as soon as the another return address has been read out of the system stack.

With the objects of the invention in view, there is also provided a program-controlled unit containing: an address calculating unit, a program memory and a prefetch unit coupled to the address calculating unit and the program memory. The prefetch unit is configured for: reading data representing instructions out of the program memory, extracting the instructions contained therein and providing the instructions for fetching by the address calculating unit to process the instructions further; and searching the instructions for an instruction, an execution of which results or can result in a jump and predicting for the instruction found during the process whether the execution of the instruction will result in a jump or not.

Depending on the result of the prediction, the prefetch unit continues to operate in such a manner that following the instruction, the execution of which results or can result in a jump, a further instruction which, according to the prediction, must be executed thereafter, is provided for fetching by the address calculating unit for processing the instructions further. The prefetch unit includes an alternative instruction storage device having data written into, the data representing instructions to be executed if no jump were to be executed in a case where it has been predicted, for an instruction, that an execution of the instruction results in a jump.

In accordance with a further feature of the invention, the prefetch unit reads out the data stored in the program memory and subjects a number of instructions per clock period to actions to be performed on the instructions.

In accordance with an added feature of the invention, there is provided an instruction storage device. The address calculating unit is configured to provide instructions for fetching and to process the instructions by writing the instructions into the instruction storage device.

In accordance with an additional feature of the invention, the instructions stored in the instruction storage device can be read out sequentially by the address calculating unit for processing the instructions further.

In accordance with yet another feature of the invention, the prefetch unit includes instruction registers for temporarily storing and transferring the instructions to the instruction storage device.

In accordance with yet a further feature of the invention, the alternative instruction storage device is formed by a cache memory, the cache memory being so small that the cache memory can be accessed without wait cycles.

In accordance with yet an added feature of the invention, only instructions already stored in the instruction registers, at a time when it is predicted that an execution of an instruction will result in a jump, are written into the alternative instruction storage device.

In accordance with yet an additional feature of the invention, an instruction address for at least one of alternative instruction storage device entries is additionally stored.

In accordance with again another feature of the invention, the prefetch unit, in the case of a request to provide certain instructions, checks if the instructions are stored in the alternative instruction storage device and, if affirmative, uses the instructions stored therein.

In accordance with again a further feature of the invention, the instructions stored in the alternative instruction storage device are transferred to a location from where the instructions had been transferred into the alternative instruction storage device.

In accordance with again an added feature of the invention, the instructions stored in the alternative instruction storage device are transferred into instruction registers.

With the objects of the invention in view, there is further provided a program-controlled unit containing an address calculating unit, a program memory, and a prefetch unit coupled to the address calculating unit and the program memory. The prefetch unit is configured for: reading data representing instructions out of the program memory, extracting the instructions contained therein and providing the instructions for fetching by the address calculating unit to process the instructions further; and searching the instructions for an instruction, an execution of which results or can result in a jump and predicting for the instruction found during the process whether the execution of the instruction will result in a jump or not.

Depending on the result of the prediction, the prefetch unit continues to operate in such a manner that following the instruction, the execution of which results or can result in a jump, a further instruction which, according to the prediction, must be executed thereafter, is provided for fetching by the address calculating unit for processing the instructions further. At times when the prefetch unit need not be active otherwise, the prefetch unit is further configured for reading from the program memory instructions that must be executed if an instruction, which results or can result in a jump, is executed differently from a predicted manner.

In accordance with another further feature of the invention, there is provided an instruction storage device. The address calculating unit is configured to provide instructions for fetching and to process the instructions by writing the instructions into the instruction storage device.

In accordance with another further feature of the invention, the instructions stored in the instruction storage device can be read out sequentially by the address calculating unit for processing the instructions further.

In accordance with another further feature of the invention, the prefetch unit includes instruction registers for temporarily storing and transferring the instructions to the instruction storage device.

In accordance with another further feature of the invention, the instruction storage device is operated such that it can be used as a First-in First-out storage device.

In accordance with another further feature of the invention, the instruction storage device can be placed into an operating mode in which the instruction storage device can be used as a random access memory.

In accordance with another further feature of the invention, the instruction storage device is placed into the operating mode when a loop to be executed repeatedly is completely stored in the instruction storage device.

In accordance with another further feature of the invention, when the loop to be executed repeatedly is stored completely in the instruction storage device, instructions belonging to the loop are repeatedly read out of the instruction storage device without being repeatedly written thereinto.

In accordance with another further feature of the invention, the prefetch unit, during times when there is no necessity of providing further instructions for fetching by the address calculating unit for processing the instructions further, reads instructions out of the program memory that must be executed when an instruction, located in one of the instruction storage device and instruction processing pipeline stages following the prefetch unit, and the execution of which results or can result in a jump, is executed differently from the predicted manner.

In accordance with another further feature of the invention, the prefetch unit, during times when the loop to be executed repeatedly is stored completely in the instruction storage device, and the instructions belonging to the loop are repeatedly read out of the instruction storage device without being repeatedly written into it, reads instructions from the program memory which must be executed after leaving the loop.

In accordance with another further feature of the invention, the instructions, read out of the program memory, which must be executed after leaving the loop, are only written into the instruction storage device during the execution of the loop if no instructions belonging to the loop are overwritten in the instruction storage device as a result.

In accordance with another further feature of the invention, the instructions read out of the program memory, which must be executed after leaving the loop, are not yet written into the instruction storage device during the execution of the loop.

In accordance with a concomitant feature of the invention, there is provided a mechanism for comparing an address of the instruction which must be executed after leaving the loop with another address of a first one of instructions available for processing in instruction registers and instruction storage device.

Further, in the program-controlled units, it is generally much rare that pauses in the instruction execution occur following an instruction, the execution of which results or can result in a jump.

However, the pauses can also occur in such program-controlled units. This is the case, if it cannot be predicted with certainty if an instruction (the execution of which results or can result in a jump) will actually result in a jump and/or if the destination of the jump cannot be predicted, or cannot be predicted with certainty.

The present invention is, therefore, based on the object of developing the program-controlled unit in such a manner that the pauses, which can occur after the execution of an instruction, which results or can result in a jump, can be avoided or shortened.

The program-controlled units according to the invention are characterized in that:

a return address storage device is provided in which the addresses of the instructions (which must be executed after the instructions that initiate the continuation of a processing of an instruction sequence temporarily interrupted by the execution of other instructions) are stored, or, respectively;

that an alternative instruction storage device is provided into which data are written which represent instructions which would have to be executed if no jump were to be executed, in the case where it has been predicted for an instruction that its execution results in a jump or, respectively; and

that at times, at which it does not need to be active in other respects, the prefetch unit reads, from the program memory, instructions which must be executed if an instruction which results or can result in a jump is executed differently from the predicted manner.

Such features are found to be advantageous if it has been falsely predicted whether an instruction which results or can result in a jump is executed or not and/or if—for example, in the case of a return instruction—for an instruction which results or can result in a jump, the destination of a jump which may have to be executed cannot be predicted. If a false prediction is detected and/or if the initially unknown destination of a jump which may have to be executed is established, the pipeline stage detecting the false prediction or, respectively, determining the destination of the jump, issues a request to the prefetch unit, as usual, to procure the instructions (actually) to be executed and to provide them for fetching by its downstream pipeline stages.

In the program-controlled units, the instructions are already available in the prefetch unit at the time at which the corresponding request is issued to the prefetch unit or, respectively, the instructions (if they are not yet available in the prefetch unit at the time of the request) can be requested and/or fetched from the program memory earlier than usual.

As a result, the pauses, which occur after the execution of an instruction (which results or can result in a jump), can be either avoided completely or reduced to a minimum.

Accordingly, the present invention includes a program-controlled unit containing a prefetch unit, which reads data representing instructions out of a program memory, extracts the instructions contained therein and provides them for fetching by a unit processing the instructions further, and searches the instructions for instructions, the execution of which results or can result in a jump, predicts for the instructions found during this process whether their execution will result in a jump or not. Depending on the result of the prediction, the includes a program-controlled unit containing a prefetch continues to operate in such a manner that following an instruction, the execution of which results or can result in a jump, the instruction which, according to the prediction, must be executed thereafter, is provided for fetching by the unit processing the instructions further. Other features which are considered as characteristic for the invention are set forth in the appended claims.

Although the invention is illustrated and described herein as embodied in a program-controlled unit having a prefetch unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram representing parts of the program-controlled unit described hereinafter (which are of particular interest herein); and

FIG. 2 is a block diagram representing a format of entries, which can be stored in a return stack according to FIG. 1.

### DESCRIPTION OF THE PREFERRED EMBODIMENTS

A program-controlled unit, described in greater detail below, includes a microprocessor or a microcontroller. However, it could also be any other program-controlled unit by which instructions stored in a program memory can be sequentially executed.

For the sake of completeness, it is pointed out that only the components of the program-controlled unit that are of particular interest herein (especially, the instruction processing pipeline of the unit) are shown and described.

The program-controlled unit considered operates in accordance with the pipeline principle. In program-controlled units operating in accordance with the pipeline principle, instructions to be executed are processed in a number of successive incremental steps and different incremental steps can be executed simultaneously for different instructions. That is to say whilst the nth incremental step is executed for an x^{th} instruction, the (n−1)^{th} incremental step is simultaneously executed for an (x+1)^{th} instruction to be executed thereafter, the (n−2)^{th} incremental step is executed for an (x+2)^{th} instruction to be executed thereafter, etc..

In the example considered, a four-stage pipeline is used. That is, the instructions to be executed by the program-controlled unit are processed in four incremental steps.

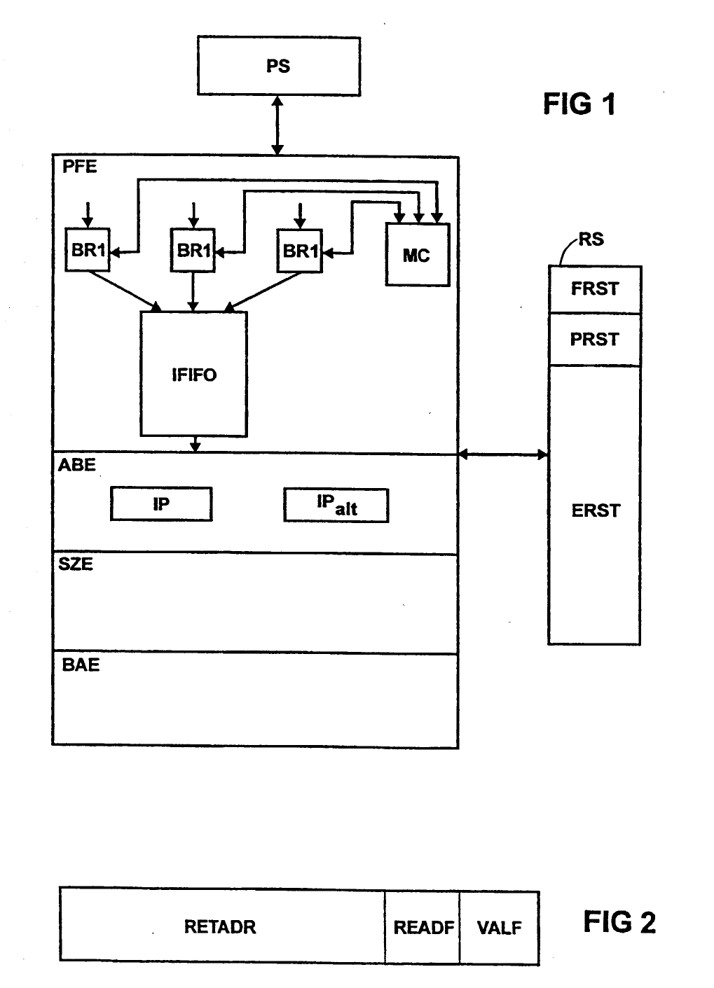

Referring now to the figures of the drawings in detail and first, particularly to FIG. 1 thereof, there is shown a basic configuration of such an instruction processing pipeline.

In the example considered, the four pipeline stages are formed by a prefetch unit PFE, an address calculating unit ABE, a memory access unit SZE and an instruction execution unit BAE.

The prefetch unit PFE fetches data representing instructions from a program memory PS provided within or outside the program-controlled unit, extracts (from the data) the instructions contained therein, writes them into instruction registers BR1 to BR3 and transfers them into an instruction storage device IFIFO. The prefetch unit PFE of the program-controlled unit:

fetches the data from the program memory PS in units of 8 bytes;

can extract up to three instructions per clock period from the data;

has three instruction registers BR1 to BR3; and

exhibits (as instruction storage device IFIFO) a storage device which can be normally operated and used like an First-in First-out “FIFO” store (an instruction FIFO) and which, in special cases (more precisely, if it is found to be advantageous that instructions stored in the instruction storage device are repeatedly read out of it without repeatedly writing the instructions into the instruction storage device which (as will be described even more precisely later) provides for a particularly efficient execution of loops to be executed repeatedly) can be operated and used like a cache memory.

It should be clear that there is no restriction on the details for configuring the prefetch unit.

The instructions written into the instruction storage device IFIFO can be sequentially fetched from the instruction storage device IFIFO and processed further by the next pipeline stage (the address calculating unit).

In addition, the prefetch unit searches the instructions for an instruction, the execution of which results or can result in a jump. If such an instruction is found, the prefetch unit makes a prediction about whether the execution of this instruction will result in a jump or not. If it predicts that a jump will be executed, it will predict the destination of the jump. If the prefetch unit can determine the destination of the jump, it continues the fetching of data representing instructions from the program memory PS at the address representing the destination of the jump, processes the data as described above, and, finally, writes the instructions obtained during the process into the instruction storage device IFIFO. As a result, an instruction (the execution of which results or can result in a jump) is followed there, as a rule, by the instructions that must be executed after the instruction.

The instructions stored in the instruction storage device IFIFO are read out sequentially by the pipeline stage following the prefetch unit PFE (i.e., by the address calculating unit ABE), and are processed in this stage and further pipeline stages. In the process, the instruction storage device IFIFO is operated and used like an FIFO store, so that the instructions stored in it are read out in the order in which they have been written into it.

If required, the address calculating unit ABE calculates (for each instruction) the addresses needed for the execution of the relevant instruction or for the execution of an instruction to be executed later by one of the existing pipeline stages.

If required, the memory access unit SZE fetches (for each instruction) the data stored in a (data) storage device, which are needed for executing the relevant instruction (that is, for example, operands of the relevant instruction).

Finally, the instructions are executed by the instruction execution unit BAE.

FIG. 1 also shows a first storage device RS and a second storage device MC (apart from other devices). The storage devices will be discussed in more detail later.

The program-controlled unit is distinguished by, among other things, the presence of a return address storage device in which the addresses of the instructions are stored that must be executed following instructions that initiate the continuation of a processing of an instruction sequence temporarily interrupted by the execution of other instructions.

An instruction, the execution of which initiates the continuation of a processing of an instruction sequence temporarily interrupted by the execution of other instructions is a “return instruction”. An instruction that results in the interruption of the execution of an instruction sequence is a “call” instruction.

A call instruction initiates execution of a subroutine; the return instruction following the call instruction causes a return from the subroutine called up by the call instruction to the main program or to another subroutine.

It should be pointed out (even at this point) that there is no restriction to the examples mentioned. The instructions, the execution of which results in a return, can also be instructions other than the return instructions. Neither do they need to represent a return from a subroutine into the main program or into another subroutine; for example, it could also be a return from an interrupt service routine to the point at which the program actually to be executed had been interrupted.

Nevertheless, for the sake of simplicity, the instructions which initiate the continuation of a processing of an instruction sequence temporarily interrupted by the execution of other instructions will be called “return instructions”, and the instructions which result in the interruption of the execution of an instruction sequence will be termed “call instructions” (in the following text).

In the example considered, the storage device in which the addresses of the instructions to be executed after a return instruction are stored is the aforementioned first storage device RS, which will be called return stack (in the following text).

The addresses of the instructions at which the program execution must be continued following return instructions are usually stored, together with other data, (particularly, contents of registers which contain them before the interruption of the program and must again contain them on continuation of the program) in the normal “system stack”.

The system stack is retained and used unchanged in spite of the partial overlap with the content of the return stack RS; the return stack is provided in addition to the system stack. However, the return stack is not a second system stack: it only stores the addresses of the instructions at which the program execution is to be continued following return instructions, and possibly data for administering the return stack entries.

Furthermore, the return stack differs from the system stack in that it can be written to and/or read out of not only by the instruction execution unit but also by other instruction processing pipeline stages. This makes it possible that, when a return instruction occurs, the prefetch unit will already be able to determine the destination of the return caused by the return instruction.

This is not possible or, if at all, possible only with disproportionately great expenditure, in program-controlled units in which the addresses of the instructions that are to be executed following return instructions are “only” stored in the system stack.

One of the reasons for this is that the entries into the system stack are usually carried out by the instruction execution unit, since it is frequently only established in this stage if and how the respective instructions are executed. As a result, it is possible that, at the time the prefetch unit finds a return instruction, there is not yet an associated return address entry in the system stack (because the call instruction with which the relevant return instruction is associated has not yet reached the instruction execution unit).

What makes it more difficult is that—as already mentioned above—it is not only the addresses of the instructions that must be executed following return instructions that are stored in the system stack, but other data such as, for example, register contents are also stored. As a result, it is very difficult and complicated for the prefetch unit to reach the addresses of the instructions to be executed following return instructions without changing the system stack content, particularly if the system stack is formed by a Last-in First-out (LIFO) store as normally used.

In the example considered, the return stack is composed of three parts. The three parts [first (one), second (another) and third (further) parts] are designated by FRST, PRST and ERST (in FIG. 1).

In each of the three return stack parts, addresses of instructions, which must be executed following return instructions are entered. However, the entries into the return stack parts are made in different phases of the instruction processing and are triggered by different events.

As will be better understood later, dividing the return stack into a number of parts allows return stack entries, which have been made due to an error in the prediction about if an instruction which can result in a jump will actually result in a jump, to be handled more easily.

In the example considered, the FRST part and the PRST parts of the return stack are configured for a single entry, and the ERST part is configured for a multiple number of entries (four in the present case). It should be clear that the respective numbers of possible entries into the individual return stack parts can be of any magnitude independently of one another.

The ERST part is configured as an LIFO storage device or as a storage device behaving like an LIFO storage device.

FIG. 2 shows the format of the return stack entries. Accordingly, each return stack entry includes:

the address RETADR of the instruction, which must be executed following a return instruction (the address will be called “return address RETADR”);

a validity flag VALF, which indicates whether or not the relevant return stack entry is valid; and

a read flag READF, which indicates whether or not the relevant entry has already been used for a return instruction.

In the example considered, the return stack RS is used as follows:

If a call instruction is entered into the instruction storage device IFIFO, the address of the instruction that must be executed after the occurrence of the associated return instruction is entered in the FRST part of the return stack RS. This is the instruction, which is stored following the call instruction in the program memory. The relevant FRST part entry is flagged as valid by the validity flag VALF being set, and flagged as unread by the read flag READF being reset.

If, and so long as, the FRST part of the return stack RS is completely occupied by entries flagged as valid by the validity flag VALF, no further call instruction can be entered in the instruction storage device IFIFO. The FRST entry is only flagged as invalid when the call instruction (for which the relevant entry has been made) passes from the address calculating unit into the memory access unit.

When the call instruction reaches the address calculating unit, its address is stored in an instruction address register IP. The instruction address written into the instruction address register IP is obtained by the address calculating unit from the prefetch unit or from a determination carried out by itself. In addition, the address calculating unit also contains an alternative instruction address register IPₐₗₜ. An instruction address is written into the alternative instruction address register IPₐₗₜ. However, it is not written for every instruction passing into the address calculating unit (as in the case of the instruction address register IP), but only if an instruction following the instruction that results or can result in a jump passes into the address calculating unit. The instruction address which is written into the alternative instruction address register IPₐₗₜ is the address of the instruction at which the program execution would have to be continued after the preceding instruction, if the prediction made in the prefetch unit, about whether or not the relevant instruction results in a jump, were not correct.

In the case of the instruction that passes into the address calculating unit after the call instruction (for the sake of simplicity, this instruction will be called “call successor” instruction):

the address of the call successor instruction is written into the instruction address register IR; and

the address of the instruction at which the program execution would have to be continued if the prediction made in the prefetch unit, whether or not the preceding call instruction results in a jump, were not correct, is written into the alternative instruction address register IPₐₗₜ.

In the case of a correct prediction (about whether the call instruction will result in a jump or not), the instruction address written into the alternative instruction address register IPₐₗₜ is (at the same time) the address of the instruction at which the program execution would have to be continued when the return instruction associated with the call instruction occurs.

In the example considered, the alternative instruction address register IPₐₗₜ is a component of the PRST part of the return stack (not shown in the figures). More precisely, the alternative instruction address register IPₐₗₜ is used as the RETADR part of the PRST part of the return stack. This makes it possible to implement the return stack with minimum expenditure in practice. However, it should be pointed out, even at this point, that there is no restriction on this; the alternative instruction address register IPₐₗₜ and the PRST part of the return stack can also be formed as separate units.

In the example considered, the address of the instruction at which (in the case of a correct prediction about whether or not the call instruction results in a jump) the program execution would have to be continued, when the return instruction associated with the call instruction occurs, is written into the RETADR field of the PRST part of the return stack when the call successor instruction occurs.

Whilst the call successor instruction is in the address calculating unit, the call instruction is already in the memory access unit. The program-controlled unit is configured in such a way that it is already decided in the memory access unit if and how the call instruction is executed. If it is found that the prediction made in the prefetch unit is correct, the content of the PRST part of the return stack is transferred into its ERST part. The new entry in the ERST part of the return stack is flagged as valid and unread by setting the corresponding flags or by taking over (also by transferring) the flags from the PRST part. At the same time, the FRST and PRST entries of the return stack relating to the relevant call instruction are flagged as invalid and read.

If it is found that the call instruction is not executed, or, contrary to the prediction, does not result in a subroutine call, then the content of the PRST part is not transferred into the ERST part, and the entries in the FRST and PRST parts of the return stack are flagged as invalid.

In addition, the call successor instruction located in the address calculating unit and the instructions in the instruction storage device IFIFO must not be executed; instead, the instructions to be executed must be read out of the program memory, processed and executed.

In the case of nested call/return sequences (more precisely, if the nesting depth is greater than the maximum number of possible entries in the ERST part), all return addresses cannot be stored in the ERST part. In this case, the oldest ERST entry in each case is overwritten.

If a return instruction is discovered in the prefetch unit, the FRST part of the return stack is first searched to see if it contains a valid entry, which has not yet been read out. If so, the entry (more precisely, the RETADR field of the entry), contains the address of the instruction at which the program execution must be continued following the return instruction (the return address associated with the relevant return instruction).

If there is no corresponding entry in the FRST part of the return stack, the PRST part of the return stack is searched as to whether or not it contains a valid entry that has not yet been read. If so, this entry (more precisely, the RETADR field of the entry) contains the address of the instruction at which the program execution must be continued following the return instruction (the return address associated with the relevant return instruction).

If the PRST part of the return stack does not contain a corresponding entry, either, the entry last written into the ERST part of the return stack that is not yet read out (more precisely, the content of the RETADR field of this entry) is used as the return address associated with the return instruction.

The return stack entry used for determining the return address associated with the return instruction is flagged as read, but still remains valid. The validity flag VALF is only placed into a state indicating an invalid state of the entry when it is established that the return instruction is actually executed (this is the case when the return instruction reaches the instruction execution unit).

If there is a misprediction (that is, if the return instruction found in the prefetch unit is not executed), all read flags of the valid ERST entries of the return stack are placed into a state indicating an unread state of the entry.

To be able to reliably eliminate the possibility of a return address (which does not correspond to the return address stored in the system stack) being used—for example, because the program executed has manipulated the system stack—the return address obtained from the return stack can be compared with the return address stored in the system stack as soon as the return address has been read out of the system stack (as is normal in the case of return instructions).

The comparison is made preferably in parallel with the preparations for the execution (taking place in the instruction execution unit) of the instruction specified by the return address from the return stack, so that the comparison does not result in a delay or interruption of the instruction processing. If it is found from the comparison of the return addresses that there is no match, the processing of the instructions located in the instruction processing pipeline is stopped, and the instructions that are actually to be executed (i.e., the instructions specified by the return address from the system stack) are fetched from the program memory and executed.

If no valid entry is found in the return stack (which can be the case, for example, if the ERST part of the return stack is too small), the prefetch unit writes the return instruction for which it searched for the associated return address into the instruction storage device IFIFO, and then interrupts the fetching of other instructions from the program memory until the relevant return instruction is in the instruction execution unit. In the instruction execution unit, the return address associated with the return instruction can be determined from the system stack.

Following this, the instruction execution unit interrupts its work because the instructions at which the program execution must be continued following the return instruction are not yet in the instruction processing pipeline, of course. After the return address associated with the return instruction has been determined from the system stack, the prefetch unit is able to continue its work by using this return address. The instructions stored at the return address are thus fetched from the program memory and processed further as described. When the return successor instruction reaches the instruction execution unit, the latter resumes work and executes the instructions received.

As explained above, the provision of a return stack makes it possible to completely eliminate the pauses that had to be accepted hitherto, when return instructions occurred; it is only when the return stack is not sufficiently large that pauses in the instruction execution may have to be accepted in the case of certain return instructions.

The program-controlled unit considered above is also distinguished by the fact that it exhibits an alternative instruction storage device into which (in the case where it has been predicted for an instruction that its execution results in a jump) data representing instructions that would have to be executed if no jump were to be executed are written.

The storage device is the second storage device MC (as already mentioned above) and is called alternative instruction storage device.

The program-controlled unit considered exhibits both a return stack RS and an alternative instruction storage device MC. However, it should be pointed out at this point that there is no restriction on this. The return stack RS and the alternative instruction storage device MC can also be provided separately in each case and can be operated independently of one another.

In the example considered, the alternative instruction storage device MC is a component of the prefetch unit. It is formed by a cache memory that is only configured for a few entries (for example for only three); as a result, it provides for particularly fast access (ie., access without wait cycles), which would not be possible in the case of a large all-round cache.

If it is predicted (for an instruction which results or can result in a jump that is executed), the instructions (which have already been read out of the program memory PS by the prefetch unit and which are not the instructions that must be executed following the predicted jump) are not deleted or overwritten as previously, but are written into the alternative instruction storage device MC. In the example considered, the instructions, which are already stored in the instruction registers BR1 to BR3 of the prefetch unit but are not stored in the instruction storage device IFIFO because of the jump which will probably be executed, are written into the alternative instruction storage device MC. As will be better understood later, there is no restriction on this. It is “only” of importance that data representing instructions, which have already been fetched into the prefetch unit, are not simply deleted or overwritten, but are written into the alternative instruction storage device.

Apart from the instructions which are written into the alternative instruction storage device in a more or less extensively preprocessed stage, the address of the first (one) one of the instructions is additionally stored.

Simultaneously, or following this, the prefetch unit reads (out of the program memory) the instructions that must be executed after the execution of the jump taking place according to the prediction, extracts the instructions contained in the data obtained during the process, writes them into the instruction registers and transfers them into the instruction storage device IFIFO (from where they can pass through the further stages of the instruction processing pipeline).

Storing the instructions in the alternative instruction storage device MC is found to be advantageous, if it is found (in the memory access unit or in the instruction execution unit) that an instruction for which it has been predicted that its execution results in a jump does not in fact result in a jump. In this case, the instructions stored in the preceding pipeline stages and in the instruction storage device IFIFO are not the instructions that must be executed following the instruction for which the misprediction has been made. The execution of the instructions is, therefore, stopped and the prefetch unit provides (to the instruction storage device IFIFO) the instructions actually to be executed. In the case of conventional program-controlled units, this is done by the prefetch unit, which reads the relevant instructions out of the program memory, processes them as described and, finally, writes them into the instruction storage device IFIFO. In contrast, the prefetch unit in the program-controlled unit of the invention initially checks if the instructions to be procured are stored in the alternative instruction storage device MC. This is done by comparing the address of the first instruction (procured by the prefetch unit) with the address, which has been stored together with the instructions stored in the alternative instruction storage device MC. If a match is found during the process, the prefetch unit does not need to read the necessary instructions out of the program memory and process further as described, but can directly use the instructions stored in the alternative instruction storage device MC. For this purpose, the instructions stored in the alternative instruction storage device MC are inserted from the alternative instruction storage device MC into the part of the prefetch unit by which instructions are read out of the program memory and processed further. In the example considered, they are written back into the instruction registers BR1 to BR3, and are then processed further like instructions that have been read out of the program memory.

It should be clear and does not need to be explained further that instructions fetched from the alternative instruction storage device MC can be provided much more quickly for further processing by the subsequent pipeline stages than instructions fetched from the program memory, and are processed as described.

It is only when the instructions to be procured by the prefetch unit are not contained in the alternative instruction storage device MC that the relevant instructions must be fetched from the program memory.

The alternative instruction storage device is also found to be of advantage in call/return sequences. This is because, if the program-controlled unit does not have a return stack or if the return address associated with the return instruction is not contained in the return stack (for example, because it is not large enough for storing all return addresses), the alternative instruction storage device can also be used for quickly providing the instructions to be executed following the execution of a return instruction. In this case, the instruction execution unit issues the request to procure the instructions to be executed following the execution of the return instruction to the prefetch unit. In this case, too, the prefetch unit can first check if the instructions to be procured by it are stored in the alternative instruction storage device MC, and can then proceed as described above in the case of a misprediction about an instruction, the execution of which results or can result in a jump.

The alternative instruction storage device MC allows the pauses, which can occur after the execution of an instruction that results or can result in a jump, to be shortened considerably.

The program-controlled unit considered is also distinguished by the fact that the prefetch unit, at times when it does not need to be otherwise active, reads instructions from the program memory that must be executed, if an instruction which results or can result in a jump is executed differently from the predicted manner.

The case where the prefetch unit can be inactive (i.e., it does not need to fetch any instructions from the program memory and process them as described) occurs, in particular, if there is temporarily no requirement to write further instructions into the instruction storage device IFIFO. This is the case, for example, if loops to be executed repeatedly are stored completely in the instruction storage device IFIFO and the instructions belonging to the loop can be repeatedly read out of the instruction storage device without these instructions being newly written into it.

For this purpose, the instruction storage device IFIFO of the program-controlled unit considered presently can be placed into an operating mode in which it no longer operates like an FIFO memory, but operates like a random access memory. The repeated reading-out of instructions stored in the instruction storage device IFIFO provides for a particularly efficient manner of processing loops to be executed repeatedly and operates as follows: before it is established that the instructions to be executed represent a loop to be executed repeatedly, the program-controlled unit operates “normally” as described above. That is, the prefetch unit continuously fetches instructions from the program memory, processes them as described and, finally, writes them into the instruction storage device IFIFO from which they are then sequentially read out and executed.

In contrast to conventional program-controlled units, the prefetch unit of the program-controlled unit of the present invention additionally checks if the fetched instructions can be the instructions of a loop to be executed repeatedly. The prefetch unit assumes this to be the case if it finds an instruction, which results or can result in a jump, and if the destination of the jump of the checked instruction is an instruction address that is not too far away from the address of the checked instruction. If, in fact, a loop is being repeatedly executed, the current instruction would have to be the return instruction to the beginning of the loop; the instruction to be executed following the current instruction would have to be the first instruction of the loop.

If after some instructions later (more precisely, when the end of the loop has again been reached by the instruction, which, in the case of the repeated execution of a loop would have to be the return instruction), a jump occurs to the instruction that would have to be the first instruction of the loop in the case of the repeated execution of a loop and if the latter is still stored in the instruction storage device IFIFO, it can be assumed that, in fact, a loop is repeatedly being executed and that the loop is so short that it can be stored completely in the instruction storage device IFIFO. In this case, the instruction storage device IFIFO in the program-controlled unit considered is operated, until the loop is left, in such a manner that the instructions of the loop already stored in it are repeatedly output from it.

This dispenses with the necessity of the prefetch unit continuously having to read the instructions belonging to the loop out of the program memory again and having to process them as described; the prefetch unit can then be inactive until the loop executed from the instruction storage device IFIFO is left. In fact, the prefetch unit must be deactivated at least partially because any unhindered further writing of instructions into the instruction storage device IFIFO entails the risk that the instructions to be repeatedly output from the instruction storage device IFIFO (i.e., the instructions belonging to the loop) are overwritten; as a result, the manner of loop execution described would be disturbed or stopped.

In the example considered, the times, at which short loops to be executed repeatedly are executed out of the instruction storage device IFIFO as described, are used for reading the instructions out of the program memory that must be executed after leaving the loop.

During the times at which it does not have to fulfill another task, the prefetch unit reads the instructions to be executed after leaving the loop out of the program memory and treats them like “normal” instructions until they are written into the instruction registers BR1 to BR3.

However, the instructions stored in the instruction registers are not written into the instruction storage device IFIFO, or only partially (so that no instructions belonging to the loop are overwritten) written, differently from instructions that must be executed immediately. If it is intended to exit the loop that is executed simultaneously out of the instruction storage device IFIFO, the instruction located at the end of the loop (the execution of which resulted in a return to the beginning of the loop during the repeated execution of the loop) no longer causes a return. This is detected by the storage access unit or the instruction execution unit, which then requests (as is usual in the case of a misprediction of a jump) the provision of instructions, which are to be processed after the jump that has not been executed. The instructions are already available in the instruction registers BR1 to BR3 of the prefetch unit or possibly even in the instruction storage device IFIFO; as a result, they can be fetched from the instruction storage device IFIFO and processed immediately or after a minimum pause. Consequently, a loop executed repeatedly can be exited without interruption or, in any case, without significant interruption.

In order to be able to reliably eliminate the possibility that the instructions provided in the instruction registers BR1 to BR3 and/or the instruction storage device IFIFO for processing are not the instructions, which have to be actually executed after the jump out of the loop (for example, because it is left in a different manner from that expected), the address of the instruction to be actually executed (after leaving the loop) can be compared with the address of the first one of the instructions provided (for processing) to the instruction registers BR1 to BR3 and/or the instruction storage device IFIFO. If it is found during the comparison that there is no match, the instructions to be actually executed are fetched from the program memory and executed.

Thus, the measures described above make it possible that the pauses that can occur after the execution of an instruction, which results or can result in a jump, can be either completely avoided or at least distinctly shortened.

We claim:

1. A program-controlled unit, comprising:
an address calculating unit;
a program memory;
a prefetch unit coupled to said address calculating unit and to said program memory, said prefetch unit configured for:
reading data representing instructions out of said program memory, extracting the instructions and providing the instructions for fetching by said address calculating unit to process the instructions further;
searching the instructions for an instruction, an execution of which results or can result in a jump;
predicting for the instruction found during the process if the execution of the instruction will result in a jump;
depending on the result of the prediction, continuing to operate in such a manner as to cause, following the instruction, the execution of which results or can result in a jump, a further instruction which, according to the prediction, must be executed thereafter to be provided for fetching by said address calculating unit for processing the instructions further; and
a return address storage device coupled to said address calculating unit, said return address storage device configured for storing addresses of the instructions that must be executed after instructions, which initiate a continuation of a processing of an instruction sequence temporarily interrupted by an execution of other instructions.

2. The program-controlled unit according to claim 1, wherein said prefetch unit reads out the data stored in the program memory and subjects a number of instructions per clock period to actions to be performed on the instructions.

3. The program-controlled unit according to claim 1, further comprising: an instruction storage device, said address calculating unit configured to provide instructions for fetching and to process the instructions by writing the instructions into said instruction storage device.

4. The program-controlled unit according to claim 3, wherein the instructions stored in said instruction storage device can be read out sequentially by said address calculating unit for processing the instructions further.

5. The program-controlled unit according to claim 3, wherein said prefetch unit includes instruction registers for temporarily storing and transferring the instructions to said instruction storage device.

6. The program-controlled unit according to claim 1, further comprising:
an instruction processing pipeline having pipeline stages, said unit being one of said pipeline stages of said instruction processing pipeline.

7. The program-controlled unit according to claim 1, wherein said return address storage device includes entries and stores only addresses of the instructions to be executed following instructions initiating a continuation of a processing of an instruction sequence temporarily interrupted by an execution of other instructions, and information relating to the entries in said return address storage device.

8. The program-controlled unit according to claim 7, wherein the information relating to the entries includes a read flag for specifying if a relevant return address storage device entry has already been used.

9. The program-controlled unit according to claim 8, wherein the information relating to the entries includes a validity flag for specifying if the relevant return address storage device entry is valid.

10. The program-controlled unit according to claim 7, further comprising a system stack for storing the addresses.

11. The program-controlled unit according to claim 1, wherein said return address storage device can be written into and read out of by said prefetch unit.

12. The program-controlled unit according to claim 1, wherein the instructions, initiating the continuation of the processing of the instruction sequence temporarily interrupted by the execution of the other instructions, are return instructions.

13. The program-controlled according to claim 1, wherein the temporary interruption of the processing of the instruction sequence is caused by a call instruction.

14. The program-controlled unit according to claim 1, wherein the temporary interruption is caused by an interrupt request.

15. The program-controlled unit according to claim 1, wherein the return address storage device is divided into a plurality of parts, into which addresses are written, and out of which addresses are read in response to different events.

16. The program-controlled unit according to claim 15, wherein an entry is made in one of said parts, if an instruction initiating the temporary interruption of the processing of the instruction sequence is written into said instruction storage device.

17. The program-controlled unit according to claim 16, wherein the entry is made in another of said parts, if the instruction initiating temporary interruption of the processing of the instruction sequence is prepared for execution in one of said instruction processing pipeline stages following said prefetch unit.

18. The program-controlled unit according to claim 17, wherein the entry in the another part is made by an instruction processing pipeline stage by which addresses needed for executing the instruction currently located therein and for instructions to be executed later are determined.

19. The program-controlled unit according to claim 18, wherein said instruction processing pipeline stage writing into said another part contains an address register and writes the determined addresses into said instruction address register.

20. The program-controlled unit according to claim 19, wherein said instruction processing pipeline stage includes an alternative instruction address register, and in the event that a preceding instruction is an instruction which results or can result in a jump, determines an address of an instruction to be executed if the preceding instruction will not be executed as predicted, and writes the address into said alternative instruction address register.

21. The program-controlled unit according to claim 20, wherein said alternative instruction address register is a part of said another return address storage device part intended for instruction address storage.

22. The program-controlled unit according to claim 16, wherein the entry is made in a further return address storage device part, if it is established that the instruction initiating the temporary interruption of the processing of an instruction sequence is executed as predicted.

23. The program-controlled unit according to claim 22, wherein the entry in said further part is made by transferring one of said entry made in said one of said parts and said entry made in said another of said parts into said further return address storage device part.

24. The program-controlled unit according to claim 23, wherein an instruction address stored in said another part is transferred into said further part if an instruction, which must be executed following the instruction initiates the temporary interruption of the processing of the instruction sequence, is located in said instruction processing pipeline stage that writes into said another part.

25. The program-controlled unit according to claim 7, wherein the return address storage device entries are flagged as valid and unread upon being entered into said return address storage device.

26. The program-controlled unit according to claim 23, wherein the entries in said first and parts are flagged as invalid when the entry in said another return address storage device part is transferred into said further return address storage device part.

27. The program-controlled unit according to claim 23, wherein the entries in the said and another parts are flagged as invalid if it is found that the instruction initiating the temporary interruption of the processing of the instruction sequence is not executed as predicted.

28. The program-controlled unit according to claim 1, wherein when an instruction occurs, which initiates the continuation of a processing of an instruction sequence temporarily interrupted by execution of other instructions, an address of an instruction to be executed following the occurred instruction is read out of said return address storage device.

29. The program-controlled unit according to claim 28, wherein said prefetch unit, when an instruction occurs, which initiates the continuation of a processing of an instruction sequence temporarily interrupted by the execution of other instructions, first looks in said one part to see if said one part contains a valid and unread entry, and, if so, uses the entry as an associated return address.

30. The program-controlled unit according to claim 29, wherein said prefetch unit, if no valid and unread entry exists in said one part, looks in said another part to see if said another part contains a valid and unread entry and, if so, uses the entry as the associated return address.

31. The program-controlled unit according to claim 30, wherein said prefetch unit, if no valid and unread entry exists in said another part either, looks in said further part to see if said further part contains a valid and unread entry and, if affirmative, uses said entry as the associated return address.

32. The program-controlled unit according to claim 30, wherein an entry used as an associated return address is flagged as read.

33. The program-controlled unit according to claim 32, wherein a return address storage device entry already flagged as read is again flagged as unread if an instruction, in response to the occurrence of which the return address storage device entry has been read out and used as the return address, is not executed as predicted.

34. The program-controlled unit according to claim 32, wherein a return address storage device entry is flagged as invalid if it is established that an instruction, in response to the occurrence of which a relevant return address storage device entry has been read out and used as the return address, is executed as predicted.

35. The program-controlled unit according to claim 10, further comprising means for comparing a return address obtained from said return address storage device with another return address stored in said system stack as soon as the another return address has been read out of said system stack.

36. A program-controlled unit, comprising:
an address calculating unit;
a program memory;
a prefetch unit coupled to said address calculating unit and to said program memory, said prefetch unit configured for:
reading data representing instructions out of said program memory, extracting the instructions and providing the instructions for fetching by said address calculating unit to process the instructions further;
searching the instructions for an instruction, an execution of which results or can result in a jump;
predicting for the instruction found during the process if the execution of the instruction will result in a jump;
depending on the result of the prediction, continuing to operate in such a manner as to cause, following the instruction, the execution of which results or can result in a jump, a further instruction which, according to the prediction, must be executed thereafter to be provided for fetching by said address calculating unit for processing the instructions further; and
said prefetch unit including an alternative instruction storage device having data written thereinto, the data representing instructions to be executed if no jump were to be executed in a case where it has been predicted, for an instruction, that an execution of the instruction results in a jump.

37. The program-controlled unit according to claim 36, wherein said prefetch unit reads out the data stored in the program memory and subjects a number of instructions per clock period to actions to be performed on the instructions.

38. The program-controlled unit according to claim 36, further comprising: an instruction storage device, said address calculating unit configured to provide instructions for fetching and to process the instructions by writing the instructions into said instruction storage device.

39. The program-controlled unit according to claim 38, wherein the instructions stored in said instruction storage device can be read out sequentially by said address calculating unit for processing the instructions further.

40. The program-controlled unit according to claim 38, wherein said prefetch unit includes instruction registers for temporarily storing and transferring the instructions to said instruction storage device.

41. The program-controlled unit according to claim 36, wherein said alternative instruction storage device is formed by a cache memory, said cache memory being small enough to permit said cache memory to be accessed without wait cycles.

42. The program-controlled unit according to claim 36, wherein only instructions already fetched from said program memory by said prefetch unit, at a time when it is predicted that an execution of an instruction will result in a jump, are written into said alternative instruction storage device.

43. The program-controlled unit according to claim 40, wherein only instructions already stored in said instruction registers, at a time when it is predicted that an execution of an instruction will result in a jump, are written into said alternative instruction storage device.

44. The program-controlled unit according to claim 36, wherein an instruction address for at least one alternative instruction storage device entry is additionally stored.

45. The program-controlled unit according to claim 36, wherein said prefetch unit, upon a request to provide certain instructions, checks if the instructions are stored in said alternative instruction storage device and, if so, uses the instructions stored therein.

46. The program-controlled unit according to claim 45, wherein the instructions stored in said alternative instruction storage device are transferred to a location wherefrom the instructions had been transferred into said alternative instruction storage device.

47. The program-controlled unit according to claim 45, wherein the instructions stored in said alternative instruction storage device are transferred into instruction registers.

48. A program-controlled unit comprising:
an address calculating unit;
a program memory;
a prefetch unit coupled to said address calculating unit and to said program memory, said prefetch unit configured for:
reading data representing instructions out of said program memory, extracting the instructions and providing the instructions for fetching by said address calculating unit to process the instructions further;
searching the instructions for an instruction, an execution of which results or can result in a jump;
predicting for the instruction found during the process if the execution of the instruction will result in a jump;
depending on the result of the prediction, continuing to operate in such a manner as to cause, following the instruction, the execution of which results or can result in a jump, a further instruction which, according to the prediction, must be executed thereafter to be provided for fetching by said address calculating unit for processing the instructions further; and
at times when said prefetch unit need not be active otherwise, said prefetch unit further configured for reading from said program memory instructions that must be executed if an instruction, which results or can result in a jump, is executed differently from a predicted manner.

49. The program-controlled unit according to claim 48, further comprising: an instruction storage device, said address calculating unit configured to provide instructions for fetching and to process the instructions by writing the instructions into said instruction storage device.

50. The program-controlled unit according to claim 49, wherein the instructions stored in said instruction storage device can be read out sequentially by said address calculating unit for processing the instructions further.

51. The program-controlled unit according to claim 49, wherein said prefetch unit includes instruction registers for temporarily storing and transferring the instructions to said instruction storage device.

52. The program-controlled unit according to claim 49, wherein said instruction storage device is operated to used as a First-in First-out storage device.

53. The program-controlled unit according to claim 49, wherein said instruction storage device can be placed into an operating mode in which said instruction storage device can be used as a random access memory.

54. The program-controlled unit according to claim 53, wherein said instruction storage device is placed into the operating mode when a loop to be executed repeatedly is completely stored in said instruction storage device.

55. The program-controlled unit according to claim 53, wherein when the loop to be executed repeatedly is stored completely in said instruction storage device, and instructions belonging to the loop are repeatedly read out of said instruction storage device without being repeatedly written thereinto.

56. The program-controlled unit according to claim 48, wherein said prefetch unit, during times of no necessity of providing further instructions for fetching by said address calculating unit for processing the instructions further, reads instructions out of said program memory that must be executed when an instruction, located in one of said instruction storage device and instruction processing pipeline stages following said prefetch unit, and the execution of which results or can result in a jump, is executed differently from the predicted manner.

57. The program-controlled unit according to claim 55, wherein said prefetch unit, during times when the loop to be executed repeatedly is stored completely in said instruction storage device, and the instructions belonging to the loop are repeatedly read out of said instruction storage device without being repeatedly written into it, reads instructions from said program memory which must be executed after leaving the loop.

58. The program-controlled unit according to claim 57, wherein the instructions, read out of said program memory w which must be executed after leaving the loop, are only written into said instruction storage device during the execution of the loop if no instructions belonging to the loop are overwritten in said instruction storage device as a result.

59. The program-controlled unit according to claim 57, wherein the instructions read out of said program memory, which must be executed after leaving the loop, are not yet written into said instruction storage device during the execution of the loop.

60. The program-controlled unit according to claim 57, further comprising means for comparing an address of the instruction which must be executed after leaving the loop with another address of an earliest one of instructions available for processing in instruction registers and said instruction storage device.
